(19) United States
(12) Patent Application Publication
(10) Pub. No.: US 2026/0268126 A1
(43) Pub. Date: Sep. 10, 2026

(54) METHODS AND APPARATUS FOR FOUNDATIONAL MODEL COMPRESSION

(71) Applicant: Huawei Cloud Computing Technologies Co., Ltd., Guizhou (CN)

(72) Inventors: Mohsen Gholami, Burnaby (CA); Mohammad Akbari, Coquitlam (CA); Kevin James Cannons, Vancouver (CA); Yong Zhang, Richmond (CA)

(73) Assignee: Huawei Cloud Computing Technologies Co., Ltd., Guizhou (CN)

(21) Appl. No.: 19/072,204

(22) Filed: Mar. 6, 2025

(51) Int. Cl. G06N 3/0495; G06N 3/0475

(52) U.S. Cl. CPC G06N 3/0495; G06N 3/0475

(57) ABSTRACT

There is provided a method for compressing an Artificial Intelligence (AI) model comprising a neural network. The method involves running the model using calibration data, followed by evaluating the activation sparsity and the importance of each model layer. Based on this evaluation, each layer is more or less compressed, until a target compression ratio is achieved. In some embodiments, the type of compression (quantization, or low rank decomposition) is based on the rank deficiency of a layer. In some embodiments, the compression may be adjusted dynamically at inference time.

### CROSS-REFERENCE TO RELATED APPLICATIONS

The present application is the first application for this disclosure.

### FIELD OF THE DISCLOSURE

The present disclosure relates to neural networks. Specifically, the present disclosure provides a method for compression a neural network model based on activation sparsity.

### BACKGROUND

Large Multimodal Models (LMMs) have garnered significant attention in recent years due to their impressive performance in image and video language comprehension. Despite their substantial applications, LMMs are computationally expensive, which limits their broader use. For instance, 70B models like LLaVa-Onevision require 140 GB of GPU memory to operate at 16-bit precision. Moreover, the inference of LMMs requires significant electricity consumption. To address these problems, post-training compression techniques such as quantization and low-rank factorization have been proposed.

Quantization is the process of reducing the size of a model by changing the representation of certain values such as weights from a higher precision representation with a large number of bits, to a lower precision representation with a smaller number of bits.

Low-rank factorization, or decomposition, is a process which involves using smaller matrices which are functionally equivalent to a larger matrix when performing computations.

In general, model compression seeks to solve for the following equation:

$$arg {min}_{\hat{W}} ‖ WX - \hat{W} X ‖$$

where W is the original weights matrix for a model, and Ŵ is a compressed weight matrix. Specifically, the question is to find Ŵ for which the difference between WX and ŴX is minimized.

The prior art includes different solutions for model compression using quantization, for example in Frantar et al., GPTQ: Accurate Post-Traininq Quantization for Generative Pre-trained Transformers, arXiv:2210.17323v2, hereinafter “Frantar-1”, in Chee et al., QuIP: 2-Bit Quantization of Large Lanquaqe Models With Guarantees, arXiv:2307.13304, in Egiazarian et al., Extreme Compression of Large Language Models via Additive Quantization, arXiv:2401.06118, and in Tseng et al., QuIP #: Even Better LLM Quantization with Hadamard Incoherence and Lattice Codebooks, arXiv:2402.04396.

The prior art further includes different solutions for model compression using low-rank decomposition, such as in Lin et al., MoDeGPT: Modular Decomposition for Large Language Model Compression, arXiv:2408.09632, in Wang et al., SVD-LLM: Truncation-aware singular value decomposition for large language model compression, arXiv:2403.07378, and in Yuan et al., ASVD: Activation-aware Singular Value Decomposition for Compressing Large Language Models, arXiv:2312.05821.

Others use a combination of low-rank decomposition and quantization such as in Saha et al., Matrix Compression via Randomized Low Rank and Low Precision Factorization, arXiv:2310.11028, and in Guo et al., LQ-LoRA: Low-rank Plus Quantized Matrix Decomposition for Efficient Language Model Finetuninq, arXiv:2311.12023.

The term “sparsity” has been frequently used in model compression literature for different purposes. In general, this term has been used to mean 1) sparsity in pruning, or 2) sparsity in quantization.

Sparsity in pruning efforts aim to reduce computational and storage overhead in neural networks by selectively eliminating tensor elements according to various sparsity mask selection criteria. This means eliminating elements in model weights that have negligible values, such as in Frantar et al., SparseGPT: Massive Language Models Can Be Accurately Pruned in One-Shot, arXiv:2301.00774, hereinafter “Frantar-2”, in Sun et al., A Simple and Effective Pruning Approach for Large Language Models, arXiv:2306.11695, and in Zhang et al., LoRAPrune: Structured Pruning Meets Low-Rank Parameter-Efficient Fine-Tuninq, arXiv:2305.18403.

Dhar et al., Activation Sparsity Opportunities for Compressinq General Large Language Models, arXiv:2412.12178, investigates the tradeoff between enforcing activation sparsity and perplexity (accuracy) on state-of-the-art Large Language Models (LLMs). Their empirical analysis demonstrates that they can obtain around 50% of main memory and computing reductions for critical Feedforward Network (FFN) components with negligible accuracy degradation.

In other cases, sparsity of activation is used in the context of quantization. Shomron et al., Post-Training Sparsity-Aware Quantization, arXiv:2105.11010, proposes a sparsity-aware quantization (SPARQ) method, in which the unstructured and dynamic activation sparsity is leveraged in different representation granularities. 4-bit quantization, for example, is employed by dynamically examining the bits of 8-bit values and choosing a window of 4 bits, while first skipping zero-value bits. Moreover, instead of quantizing activation-by activation to 4 bits, Shomron et al. focuses on pairs of 8-bit activations and examine whether one of the two is equal to zero. If one is equal to zero, the second can opportunistically use the other's 4-bit budget, if both do not equal zero, then each is dynamically quantized to 4 bits.

Wang et al., Two-Step Quantization for Low-bit Neural Networks, 2018 IEEE/CVF Conference on Computer Vision and Pattern Recognition, propose that by turning a portion of the small positive activations into zeros, the quantization function can pay more attention to large values. This paper explores sparse quantization, where instead of quantizing all positive values after Rectified Linear Unit (ReLU), the paper proposes to focus on quantizing only the important values while setting the unimportant ones to zero. This assumes that larger activations are more important than smaller ones. Therefore, sparsity is introduced by setting all activations below a certain threshold to zero.

Harma et al., Effective Interplav between Sparsity and Quantization: From Theory to Practice, arXiv:2405.20935, investigates the interaction between these two methods and assesses whether their combination impacts the final model's accuracy. This paper mathematically proves that applying sparsity before quantization is the optimal sequence for these operations, minimizing errors in computation.

Each of the above papers are incorporated herein by reference.

### SUMMARY

It is an object of the present disclosure to provide an improved method for compressing a neural network.

According to a first aspect, there is provided a method for compressing a neural network comprising a plurality of layers, comprising running the neural network using calibration data as input, evaluating a sparsity of each layer of the neural network during execution over the calibration data, evaluating an importance of each layer of the neural network during execution over the calibration data, assigning a compression ratio to each layer of the neural network, the compression ratio for a given layer being a function of the sparsity and the importance of the given layer, and of a target compression ratio for the neural network, and compressing each layer of the neural network according to the assigned compression ratio.

According to an embodiment of the first aspect, said compressing uses one of quantization, low-rank decomposition, or a combination of quantization and low-rank decomposition.

According to another embodiment of the first aspect, said evaluating the sparsity uses Equation 1

$${s}_{l} ( {X}_{out} ) = 𝔼 ( I ( {X}_{out , ij} < θ ) ) \qquad Equation 1$$

where sₗ is the sparsity of layer l, Xₒᵤₜ is an output of layer l, I(X_{out,ij}<θ)) is a function that returns 1 when X_{out,ij}<θ, and 0 otherwise, and θ is a threshold.

According to yet another embodiment of the first aspect, said evaluating the importance uses Equation 2:

$${I}_{l} = 1 - 𝔼 \frac{{X}_{i n}^{T} {X}_{out}}{‖ {X}_{i n} ‖ ‖ {X}_{out} ‖} \qquad Equation 2$$

where Iₗ is the importance of layer l, Xᵢₙ is an input of layer l, and Xₒᵤₜ is an output of layer l.

According to yet another embodiment of the first aspect, said assigning the compression ratio uses Equation 3:

$$1 - {C}_{l} = 1 / {p}_{l} P ( 1 - {C}_{a v g} ) Softmax ( \frac{α {I}_{l} {p}_{l}}{{s}_{l} μ} ) \qquad Equation 3$$

where Cₗ is the compression ratio for a layer l, pₗ is the number of parameters for layer l, P is the total number of parameters for the neural network, C_{avg} is the target compression ratio, Iₗ is the importance of layer l, sₗ is the activation sparsity of layer l, and α and μ are hyperparameters.

According to yet another embodiment of the first aspect, the method further comprises evaluating a rank of a weight matrix for each layer, and selecting a compression strategy for each layer based on the rank of the weight matrix, the compression strategy being one of quantization, low-rank decomposition, or joint quantization and low-rank decomposition.

According to yet another embodiment of the first aspect, the selected compression strategy is low-rank decomposition when the rank is less than a first threshold, the selected compression strategy is joint quantization and low-rank decomposition when the rank is between the first threshold and a second threshold, and the selected compression strategy is quantization when the rank is above the second threshold.

According to yet another embodiment of the first aspect, the method further comprises inserting, between each layer, a dynamic sparsity evaluator, the dynamic sparsity evaluator being configured to evaluate a sparsity of a preceding layer during inference, and to dynamically compress a subsequent layer based on the sparsity of the preceding layer.

According to yet another embodiment of the first aspect, the neural network is one of a Large Language Model (LLM) or a Large Multimodal Model (LMM).

According to a second aspect, there is provided a computing device for compressing a neural network, the computing device comprising a processor and memory, wherein the computing device is configured to run the neural network using calibration data as input, evaluate a sparsity of each layer of the neural network during execution over the calibration data, evaluate an importance of each layer of the neural network during execution over the calibration data, assign a compression ratio to each layer of the neural network, the compression ratio for a given layer being a function of the sparsity and the importance of the given layer, and of a target compression ratio for the neural network, and compress each layer of the neural network according to the assigned compression ratio.

According to an embodiment of the second aspect, said compressing uses one of quantization, low-rank decomposition, or a combination of quantization and low-rank decomposition.

According to another embodiment of the second aspect, said evaluating the sparsity uses Equation 1:

$${s}_{l} ( {X}_{out} ) = 𝔼 ( I ( {X}_{out , ij} < θ ) ) \qquad Equation 1$$

where sₗ is the sparsity of layer l, Xₒᵤₜ is an output of layer l, I(X_{out,ij}<θ)) is a function that returns 1 when X_{out,ij}<θ, and 0 otherwise, and θ is a threshold.

According to yet another embodiment of the second aspect, said evaluating the importance uses Equation 2:

$${I}_{l} = 1 - 𝔼 \frac{{X}_{i n}^{T} {X}_{out}}{‖ {X}_{i n} ‖ ‖ {X}_{out} ‖} \qquad Equation 2$$

where Iₗ is the importance of layer l, Xᵢₙ is an input of layer l, and Xₒᵤₜ is an output of layer l.

According to yet another embodiment of the second aspect, said assigning the compression ratio uses Equation 3:

$$1 - {C}_{l} = 1 / {p}_{l} P ( 1 - {C}_{a v g} ) Softmax ( \frac{α {I}_{l} {p}_{l}}{{s}_{l} μ} ) \qquad Equation 3$$

where Cₗ is the compression ratio for a layer l, pₗ is the number of parameters for layer l, P is the total number of parameters for the neural network, C_{avg} is the target compression ratio, Iₗ is the importance of layer l, sₗ is the activation sparsity of layer l, and α and μ are hyperparameters.

According to yet another embodiment of the second aspect, the computing device is further configured to evaluate a rank of a weight matrix for each layer, and select a compression strategy for each layer based on the rank of the weight matrix, the compression strategy being one of quantization, low-rank decomposition, or joint quantization and low-rank decomposition.

According to yet another embodiment of the second aspect, the selected compression strategy is low-rank decomposition when the rank is less than a first threshold, the selected compression strategy is joint quantization and low-rank decomposition when the rank is between the first threshold and a second threshold, and the selected compression strategy is quantization when the rank is above the second threshold.

According to yet another embodiment of the second aspect, the computing device is further configured to insert, between each layer, a dynamic sparsity evaluator, the dynamic sparsity evaluator being configured to evaluate a sparsity of a preceding layer during inference, and to dynamically compress a subsequent layer based on the sparsity of the preceding layer.

According to yet another embodiment of the second aspect, the neural network is one of a Large Language Model (LLM) or a Large Multimodal Model (LMM).

According to a third aspect, there is provided a computer readable medium having stored thereon executable code for execution by a processor of a computing device, the executable code comprising instructions for running the neural network using calibration data as input, evaluating a sparsity of each layer of the neural network during execution over the calibration data, evaluating an importance of each layer of the neural network during execution over the calibration data, assigning a compression ratio to each layer of the neural network, the compression ratio for a given layer being a function of the sparsity and the importance of the given layer, and of a target compression ratio for the neural network, and compressing each layer of the neural network according to the assigned compression ratio.

### BRIEF DESCRIPTION OF THE DRAWINGS

FIG. 1 illustrates graphics plotting Mean Squared Error over sparsity.

FIG. 2 is a block diagram illustrating a high-level view of a method according to at least some embodiments of the present disclosure.

FIG. 3 is a block diagram illustrating a method for compressing a model according to at least some embodiments of the present disclosure.

FIG. 4 is a block diagram illustrating a method for compressing a model according to at least some embodiments of the present disclosure.

FIG. 5 is a block diagram of an existing model after being compressed using an embodiment of the present disclosure.

FIG. 6 is a block diagram illustrating a method for compressing a model according to at least some embodiments of the present disclosure.

FIG. 7 is a block diagram illustrating a method for dynamically compressing a model according to at least some embodiments of the present disclosure.

FIG. 8 is a block diagram of a computing device according to at least some embodiments of the present disclosure.

### DETAILED DESCRIPTION

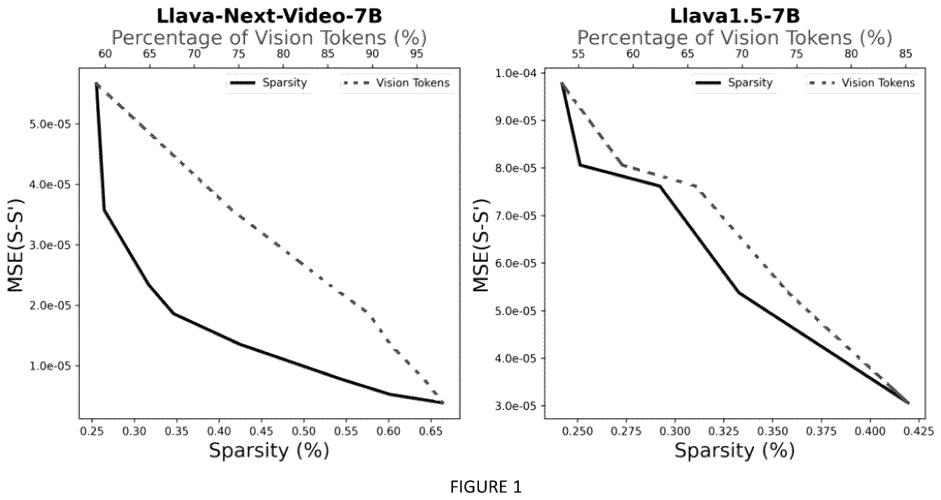

The present disclosure provides an improved method for compressing a neural network. Specifically, the present disclosure relies on the idea that when the activation output of a layer is sparser, the compression error is smaller for the same compression ratio. This is illustrated in FIG. 1, which shows the compression error of two recent foundation model, namely LLaVA-Next-Video-7B and LLaVa-1.5. As seen in FIG. 1, the error decreases when activations are sparser. Therefore, according to at least some embodiments of the present disclosure, the sparsity of a layer activation is determined, and then the compression ratio for this layer is assigned based on this sparsity.

Various techniques for compressing neural networks have been attempted. The following is a quick summary of some approaches using quantization.

In Frantar-1, it was shown that accurate large language models can be quantized to 3-4 bits/component, whereas prior post-training methods only remained accurate at 8 bits. Frantar-1 discloses quantizing a block of a weight matrix and then updating the rest of the weight matrix with the error of the quantized block.

Chee et al. improves Generalized Post-Training Quantization (GPTQ) by proposing a weight smoothing technique, incoherence processing, especially at higher compression rates.

Egiazarian et al. discloses the use of Multi-Codebook Quantization (MCQ) techniques for LLM weight compression. MCQ is a family of information retrieval methods consisting of specialized quantization algorithms to compress databases of vectors, allowing for efficient search. Unlike direct quantization (e.g. GPTQ), MCQ compresses multiple values jointly, by leveraging the mutual information of quantized values.

Tseng et al., similarly to Egiazarian et al., uses vector quantization. Their model, QuIP # also uses the smoothing technique of QuIP from Chee et al.

Shomron et al., Wang et al., and Harma et al., discussed above, also use quantization.

The following is a quick summary of some approaches using low-rank decomposition.

Yuan et al. proposes an Activation-aware Singular Value Decomposition (ASVD) and Sensitivity-based Truncation Rank Searching (STRS) for the weight matrix in the model.

Wang et al. proposes a truncation-aware data whitening technique that ensures a direct mapping between singular values and model compression loss.

Lin et al. proposes to partition the Transformer block into modules comprised of matrix pairs and reduces the hidden dimensions via reconstructing the module-level outputs using Nystrom approximation, CR decomposition, and Singular Value Decomposition (SVD).

The following is a quick summary of some approaches using a combination of quantization and low-rank decomposition.

Saha et al. proposes an algorithm for obtaining a low rank decomposition of any matrix W as W LR, where L and R are the low rank factors. Furthermore, the entries of L and R are quantized to low precision formats, thereby compressing W by using a low rank and low precision factorization.

Guo et al. proposes an iterative algorithm to decompose W such that W≈Q+LR, where Q is the quantized component which remains fixed and LR is the low-rank component.

All the above approaches discussed above suffer from various disadvantages.

Specifically, all of these approaches assign redundant bits to layers with sparse output.

Moreover, in the case of Frantar-1 and Chee et al., the models experience significant performance drop when extreme compression is performed.

Egiazarian et al. suffers from slow inference due to the codebook design. The performance drop may be recovered using fine-tuning, but that is time-consuming. For instance, quantizing a 70B model on a single A100 GPU takes 10-14 days. Similarly, Tseng et al. also uses fine-tuning to recover the performance drop caused by compression. In this case, quantizing a 70B model on a single A100 GPU takes 5 days.

Shomron et al. suffers from performance degradation due to the accumulation of errors from converting 8-bit values to 4 bits. Moreover, this model requires special hardware support, as it does not run on generic hardware.

Wang et al. does not disclose a post-training quantization method, as it requires training and therefore is computationally expensive.

Methods which use only low-rank decomposition suffer from a significant drop in performance with extreme compression (i.e. 4800% worse than the baseline FP16 model). Moreover, results are worse than quantization for the same compression ratio.

The approach in Saha et al. creates a significant performance drop in extreme compression. It does not consider rank efficiency of different weight matrices (not all weight matrix are low-rank).

The approach in Guo et al. results in slow inference due to adding low rank matrices to the quantized weight matrix, which means that more computation is needed. Moreover, this method is not memory efficient since it increases peak memory usage by adding two additional low-rank matrices to the quantized weights.

The approach of the present disclosure seeks to improve on the above approaches, resulting in a method of compression which meets the following criteria:
Ability to perform extreme compression (i.e, 2 bits);
Maintaining the accuracy of the model;
Ability to use both quantization and low-rank decomposition;
Fast inference;
Ability to use any quantization method;
Sparsity-aware compression;
Dynamic compression adjustments;
Optimized for LMMs; and
Optimal layer-wise bit allocation.

Existing methods still struggle to compress foundation models to 2-bit with negligible performance drop (e.g. accuracy). The present disclosure provides a method which diminishes the performance drop of any quantization technique by assigning bits to weights more efficiently.

Most of the prior art approaches to compression rely on after compression fine-tuning to recover any performance drop. However, fine-tuning is time-consuming and computationally expensive. The present disclosure provides a method which does not rely on time-consuming fine-tuning.

Most of the existing quantization methods assign uniform bits to all layers. However, some layers exhibit sparse outputs, allowing fewer bits to be allocated to these layers without increasing the compression error. None of the prior art proposes bit allocation based on the activation sparsity.

Prior art approaches using joint low-rank decomposition and quantization for compression of foundation models apply a uniform low-rank decomposition on all layers. However, the present disclosure proposes a solution which measures the rank deficiency (i.e. the extent to which the weight matrix is low rank) and then assigns the rank of low-rank decomposition based on rank deficiency. This provides an improvement in terms of accuracy.

The activation sparsity of foundation models dynamically changes with different inputs. For example, feeding a long video into an LMM results in sparser activations than processing a text input. When activations are sparser, the method of the present disclosure can achieve greater model compression while maintaining a fixed compression error. In contrast, the prior art does not include models which can dynamically adjust the compression ratio of an LMM or LLM in the inference stage based on the sparsity of the activation.

The present disclosure seeks to improve on the prior art and achieve the above benefits by applying compression based on an efficient way of looking at the sparsity of the activations and by adjusting the compression ratio dynamically in the inference stage based on the input. Moreover, the methods and systems proposed in this disclosure are applicable to any quantization or low-rank decomposition technique, they can be applied to different models regardless of their architecture and data type (or modalities), and do not require time-consuming fine-tuning to recover performance drops.

The present disclosure provides a method which receives as an input a foundational model, calibration data, and a target compression ratio, and produces a compressed model as output.

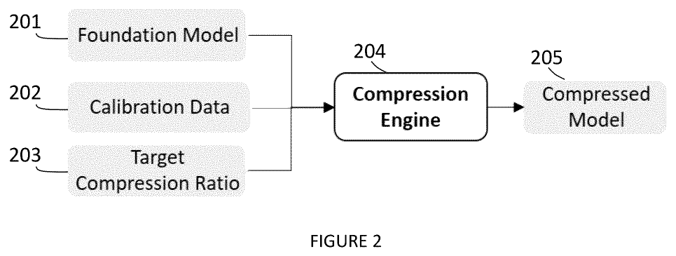

Reference is made to FIG. 2, which illustrates a high-level method according to at least some embodiments. Specifically, the inputs comprising a foundational model 201, calibration data 202, and a target compression ratio 203 are provided to a compression engine 204. The output of the compression engine is the compressed model 205.

Foundational model 201 may be an LLM, an LMM, or any neural network. Calibration data 202 may comprise multimodal data (e.g. image-text) or unimodal data (e.g. text). Target compression ratio 203 represents the average compression ratio that the user requires. For example, a user may need 80% compression for a 70B model. Compression engine 204 returns the foundation model compressed to the target compression ratio. For example, given a foundation model with checkpoint size of 100G, the checkpoint size of the returned compressed model after 80% compression will be 20G.

According to at least some embodiments, the present disclosure may also provide a method which returns a dynamic compressed model for the input foundation model. A dynamic compressed model dynamically adjusts the compression ratio for different inputs, as is described in greater detail below.

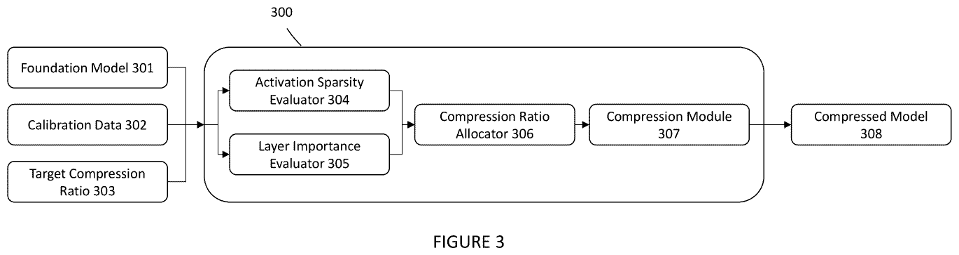

Reference is now made to FIG. 3, which shows a method for compressing a model according to at least some embodiments of the present disclosure.

As seen in FIG. 3, the inputs comprise foundational model 301, which represents the model to be compressed, calibration data 302, and a target compression ratio 303. In some embodiments, calibration data 302 and the target compression ratio 303 may be absent, and compression engine 300 may utilize default values.

Calibration data 302 may comprise input data for the model, allowing compression engine 300 to perform inference on foundational model 301. In the absence of calibration data 302, the compression engine may utilize a default text prompt as an input.

Upon receiving the input parameters, compression engine 300 measures the sparsity of activations of each layer of foundation model 301 after feeding the calibration data 302 to it. According to at least some embodiments, the sparsity for layer l may be based on Equation 1 below:

$${s}_{l} ( {X}_{out} ) = 𝔼 ( I ( {X}_{out , ij} < θ ) ) \qquad Equation 1$$

In Equation 1, Sₗ(Xₒᵤₜ) is the sparsity for layer l, as a function of the output Xₒᵤₜ of the layer l, which is produced by feeding the calibration data 302 to the foundational model 301. I(X_{out,ij}<θ) is a function which produces a value of 1 when X_{out,ij}<θ, and 0 otherwise, θ is a threshold value, E is the expected value, i.e. the mean of values. θ may be set by the user, and the optimal value for θ may vary from one model to another.

Therefore, compression engine 300 feeds calibration data 302 to foundational model 301, and allows the model to run at least up to layer l, where the output of layer l is captured and the sparsity of layer l may be computed as described above. The value of the sparsity calculated based on Equation 1 will be a value between 0 and 1, representing a proportion of neurons in layer l whose output was less than 0.

Activation sparsity evaluator 304 may measure the sparsity of each layer in model 301 in this way.

Compression engine 300 may further measure the importance of each layer l using layer importance evaluator 305. According to at least some embodiments, the layer importance evaluator 305 evaluates the importance of a layer by using cosine similarity between the input to a layer and the output of that layer. For example, the layer importance may be calculated using Equation 2 below:

$${I}_{l} = 1 - 𝔼 \frac{{X}_{i n}^{T} {X}_{out}}{‖ {X}_{i n} ‖ ‖ {X}_{out} ‖} \qquad Equation 2$$

As seen in Equation 2, the importance Iₗ of a layer l is computed based on the input matrix for layer l, Xᵢₙ, and the output matrix for layer l, Xₒᵤₜ. The operator T indicates a transpose, such that A^{T} is the transpose of matrix A. JE is expected value, i.e. the mean of the values. Iₗ is a value between 0 and 1.

The more similar the output of layer l is to its input, the less important layer l is deemed to be.

Layer importance evaluator 305 may measure the importance of every layer in model 301 in this way.

Once the activation sparsity and the importance of every layer is measured by activation sparsity evaluator 304 and layer importance evaluator 305, compression engine 300 may proceed to assign compression ratios for each layer, using compression ratio allocator 306.

In general terms, compression ratio allocator 306 assigns higher ratios for sparse layers, and lower ratios for more important layers, to obtain target compression ratio 303. According to at least some embodiments of the present disclosure, compression ratios are assigned using Equation 3 below:

$$1 - {C}_{l} = 1 / {p}_{l} P ( 1 - {C}_{a v g} ) Softmax ( \frac{α {I}_{l} {p}_{l}}{{s}_{l} μ} ) \qquad Equation 3$$

In Equation 3, C₁ is the compression ratio for a layer l, pₗ is the number of parameters for layer l, P is the total number of parameters for model 301, C_{avg} is the target compression ratio 303, 1I is the importance of layer l, sₗ is the activation sparsity of layer l, and α and μ are hyperparameters, allowing to control the weight given to importance and sparsity, respectively, when assigning compression ratios for a given layer. The optimal values for α and μ may vary from one model to another.

With each layer having been assigned a compression ratio by compression ratio allocator 306, the model may be compressed by compression module 307 to produce compressed model 308. The details of compression module 307 are outside the scope of the present disclosure. Specifically, compression module 307 may use quantization, low-rank decomposition, or a combination of quantization and low-rank decomposition. Importantly, compression module produces a module where each layer of the input model 301 is compressed by its compression ratio as determined by compression ratio allocator 306. Compressed model 308 will then have a compression ratio corresponding to target compression 303 when compared to foundation model 301, where each layer is compressed according to its sparsity and its importance, such that sparser and least important layers are more compressed, and less sparse and more important layers are less compressed.

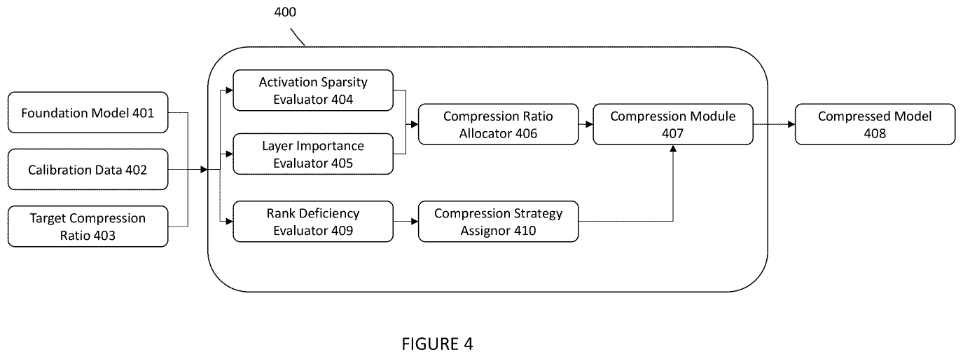

Reference is now made to FIG. 4, in which another embodiment of a compression engine according to the present disclosure is illustrated.

The embodiment of FIG. 4 is similar to the embodiment of FIG. 3, in that the input is a foundation model 401, calibration data 402, and target compression ratio 403. Compression engine 400 again comprises activation sparsity evaluator 404, layer importance evaluator 405, compression ratio allocator 406, and compression module 407. However, unlike the embodiment of FIG. 3, compression model 400 further comprises rank deficiency evaluator 409.

Rank deficiency evaluator 409 calculates the extent that a layer may be susceptible to be compressed using low-rank decomposition.

For an m×n weight matrix W of a given layer, rank deficiency evaluator 409 may calculate the rank of matrix W by first performing singular value decomposition as shown with respect to Equation 4 and Equation 5 below:

$$W = U Σ {V}^{T} \qquad Equation 4$$

$$rank ( A ) = {\sum }_{i = 1}^{min ( m , n )} I ( {σ}_{i} > ε ) \qquad Equation 5$$

In Equation 5, σᵢ represents the diagonal entry of Σ, denoted as σᵢ=Σᵢᵢ. These are known as the singular values of W. I(σᵢ>ε) is a function that returns 1 if σ_{g}>ε, and 0 otherwise, and ε is a threshold. ε may be set by the user, and the optimal value for ε may vary from one model to another.

Once the rank of the matrix W is determined by rank deficiency evaluator 409, compression strategy assignor 410 may assign a compression strategy for the given layer. According to at least some embodiments, compression strategy may be one of three options, namely quantization only, low-rank decomposition only, and combined quantization and low-rank decomposition.

According to at least some embodiments, compression strategy 411 may be selected on the basis of thresholds γ and β, such that if rank(W)<γ, only low rank decomposition is used, if γ<rank(W)<β, a combination of quantization and low rank decomposition is used, and if β<rank(W), only quantization is used.

The assigned compression strategy may then be provided to compression module 407 for the given layer. In at least some embodiments, a different compression strategy may be provided for each layer of the input model 401.

Compression module may then compress the input model 401, to produce compressed module 408, using the compression ratio for each layer, as determined by compression ratio allocator 406, and using the compression strategy for each layer, as determined by compression strategy assignor 410.

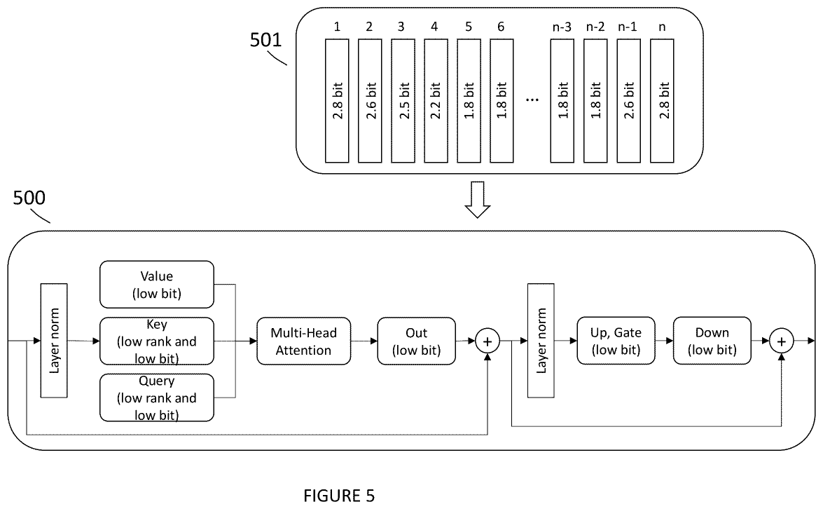

Reference is now made to FIG. 5, which illustrates a foundational model 500 with a transformer architecture, namely LLaVA1.6, after having been compressed by a method according to the present disclosure, namely the embodiment of FIG. 4. The Query and Key weight matrices have been compressed with joint low-rank factorization and quantization, while the rest of the weight matrices are compressed with quantization alone. The optimal compression ratio, represented in the format of assigned bits for each layer, is shown at 501.

As can be seen from FIG. 5, the first and last layers are compressed with smaller ratios. Specifically, layers 1 and n have been assigned 2.8 bits per weight, whereas layers 2 and n−1 have been assigned 2.6 bits per weight, and other layers have been assigned even fewer bits per weight.

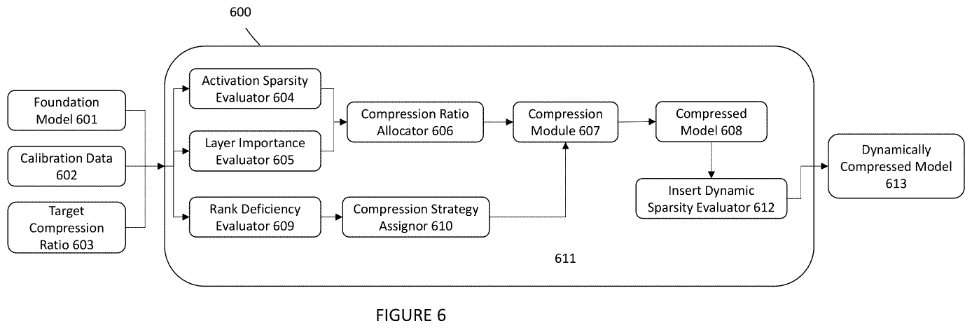

Reference is now made to FIG. 6, in which another embodiment of the present disclosure is illustrated. The embodiment of FIG. 6 is similar to the embodiment of FIG. 4, in that the input to compression engine 600 includes a foundational model 601, calibration data 602, and a target compression ratio 603.

Compression engine 600 further comprises an activation sparsity evaluator 604, a layer importance evaluator 605, a compression ratio allocator 606, a compression module 607, a rank deficiency evaluator 609, and a compression strategy assignor 610 which may assign compression strategies to different layers. Unlike the embodiment of FIG. 4, here the compression strategy is one of low-rank decomposition or a combination of low-rank decomposition and quantization.

For the most part, compression engine 600 works similarly to compression engine 400 of FIG. 4, with the distinction that compression engine 600 inserts a dynamic sparsity evaluator 612 between each layer of compressed model 608, to produce dynamically compressed model 613. Dynamic sparsity evaluator 612 may dynamically adjust the compression ratio at inference time, as is described below.

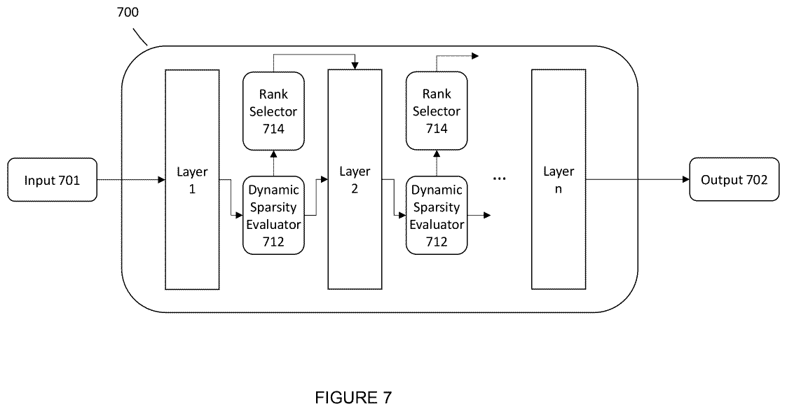

Operation of a dynamically compressed model as produced by the embodiment of FIG. 6 is illustrated with respect to FIG. 7.

As seen in FIG. 7, model 700 comprises layers 1 to N, although for the sake of simplicity only layers 1, 2, and N are shown. As described above, a dynamic sparsity evaluator 712 has been inserted between each layer of model 700. As seen in FIG. 7, a rank selector 714 has been added between each layer also.

When the input 701 is received by layer l of model 700, layer l produces an output which is received by dynamic sparsity evaluator 712. Dynamic sparsity evaluator 712 may then evaluate the sparsity of the output of layer 1. In at least some embodiments, the sparsity may be evaluated using Equation 1 described above. When activations are sparser, the compression ratio may be increased, allowing to maintain a similar compression error with higher compression ratios. When activations are less sparse, the compression ratio may be decreased, allowing again to maintain a similar compression error, with a lower compression ratio.

Specifically, the sparsity of layer 1 may be provided to rank selector 714, which may select a rank for layer 2. Rank selector 714 adjusts the rank of an already composed weight matrix. The weight matrix is already compressed by joint quantization and low-rank decomposed or solely low-rank decomposition. The rank selector merely adjusts the rank of weight matrix at the inference time.

This process may occur between each layer, up to layer n which produces output 702, allowing each layer of model 700 to dynamically adjust its compression ratio during inference time.

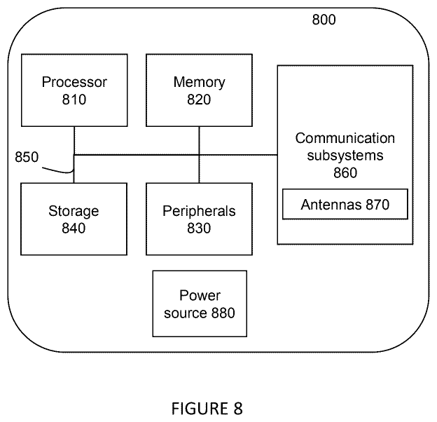

The above functionality may be implemented on any one or combination of computing devices. FIG. 8 is a block diagram of a computing device 800 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 800 may comprise a processor 810, memory 820, a mass storage device 840, and peripherals 830. Peripherals 830 may comprise, amongst others one or more input/output devices, such as a speaker, microphone, mouse, touchscreen, keypad, keyboard, printer, display, network interfaces, and the like. Communications between processor 810, memory 820, mass storage device 840, and peripherals 830 may occur through one or more buses 850.

The bus 850 may be one or more of any type of several bus architectures including a memory bus or memory controller, a peripheral bus, video bus, or the like. The processor 810 may comprise any type of electronic data processor. The memory 820 may comprise any type of system memory such as static random-access memory (SRAM), dynamic random-access memory (DRAM), synchronous DRAM (SDRAM), read-only memory (ROM), a combination thereof, or the like. In an embodiment, the memory 820 may include ROM for use at boot-up, and DRAM for program and data storage for use while executing programs.

The mass storage device 840 may comprise any type of storage device configured to store data, programs (e.g. instructions or code), and other information and to make the data, programs, and other information accessible via the bus. The mass storage device 840 may comprise, for example, one or more of a solid-state drive, hard disk drive, a magnetic disk drive, an optical disk drive, or the like. The memory 820 or mass storage 840 may store instructions, which when executed by a processor or processing unit, cause or configure the computing device 800 to perform any of the methods described herein.

Computing device 800 may further comprise a communications subsystem 860 for communicating with other computing devices or for connecting computing device 800 to a computer network. Communications subsystem 860 may comprise one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas 870 and one or more receivers/receive antennas 870. In an embodiment, the processing unit is coupled to a local-area network or a wide-area network, for data processing and communications with remote devices, such as other processing units, the Internet, remote storage facilities, or the like.

Computing device may further comprise a power source 880.

The present disclosure may be implemented on a computing device such as exemplary computing device 800. Computing device 800 may be a network element of a telecommunications network, such that the network element may be connected to other network elements of the telecommunication network, where all network elements form the telecommunication network. The network element may also receive communications from client devices connected to the telecommunication network and provide services to such client devices.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method for compressing a neural network comprising a plurality of layers, comprising:
running the neural network using calibration data as input;
evaluating a sparsity of each layer of the neural network during execution over the calibration data;
evaluating an importance of each layer of the neural network during execution over the calibration data;
assigning a compression ratio to each layer of the neural network, the compression ratio for a given layer being a function of the sparsity and the importance of the given layer, and of a target compression ratio for the neural network; and
compressing each layer of the neural network according to the assigned compression ratio.

2. The method of claim 1, wherein said compressing uses one of quantization, low-rank decomposition, or a combination of quantization and low-rank decomposition.

3. The method of claim 1, wherein said evaluating the sparsity uses Equation 1:
$${s}_{l} ( {X}_{out} ) = 𝔼 ( I ( {X}_{out , ij} < θ ) ) \qquad Equation 1$$
where sₗ is the sparsity of layer l, Xₒᵤₜ is an output of layer l, I(X_{ont,ij}<θ) is a function that returns 1 when X_{out,ij}<θ, and 0 otherwise, and θ is a threshold.

4. The method of claim 1, wherein said evaluating the importance uses Equation 2:
$${I}_{l} = 1 - 𝔼 \frac{{X}_{i n}^{T} {X}_{out}}{‖ {X}_{i n} ‖ ‖ {X}_{out} ‖} \qquad Equation 2$$
where Iₗ is the importance of layer l, Xᵢₙ is an input of layer l, and Xₒᵤₜ is an output of layer l.

5. The method of claim 1, wherein said assigning the compression ratio uses Equation 3:
$$1 - {C}_{l} = 1 / {p}_{l} P ( 1 - {C}_{a v g} ) Softmax ( \frac{α {I}_{l} {p}_{l}}{{s}_{l} μ} ) \qquad Equation 3$$
where Cₗ is the compression ratio for a layer l, pₗ is the number of parameters for layer l, P is the total number of parameters for the neural network, C_{avg} is the target compression ratio, Iₗ is the importance of layer l, sₗ is the activation sparsity of layer l, and α and μ are hyperparameters.

6. The method of claim 1, further comprising:
evaluating a rank of a weight matrix for each layer; and
selecting a compression strategy for each layer based on the rank of the weight matrix, the compression strategy being one of quantization, low-rank decomposition, or joint quantization and low-rank decomposition.

7. The method of claim 6, wherein the selected compression strategy is low-rank decomposition when the rank is less than a first threshold, the selected compression strategy is joint quantization and low-rank decomposition when the rank is between the first threshold and a second threshold, and the selected compression strategy is quantization when the rank is above the second threshold.

8. The method of claim 1, further comprising:
inserting, between each layer, a dynamic sparsity evaluator, the dynamic sparsity evaluator being configured to evaluate a sparsity of a preceding layer during inference, and to dynamically compress a subsequent layer based on the sparsity of the preceding layer.

9. The method of claim 1, wherein the neural network is one of a Large Language Model (LLM) or a Large Multimodal Model (LMM).

10. A computing device for compressing a neural network, comprising:
a processor; and
memory;
wherein the computing device is configured to:
run the neural network using calibration data as input;
evaluate a sparsity of each layer of the neural network during execution over the calibration data;
evaluate an importance of each layer of the neural network during execution over the calibration data;
assign a compression ratio to each layer of the neural network, the compression ratio for a given layer being a function of the sparsity and the importance of the given layer, and of a target compression ratio for the neural network; and
compress each layer of the neural network according to the assigned compression ratio.

11. The computing device of claim 10, wherein said compressing uses one of quantization, low-rank decomposition, or a combination of quantization and low-rank decomposition.

12. The computing device of claim 10, wherein said evaluating the sparsity uses Equation 1:
$${s}_{l} ( {X}_{out} ) = 𝔼 ( I ( {X}_{out , ij} < θ ) ) \qquad Equation 1$$
where sₗ is the sparsity of layer l, Xₒᵤₜ is an output of layer l, N is a number of neurons in layer l, I(X_{out,i}<θ) is a function that returns 1 when X_{out,i}<θ, and 0 otherwise, and θ is a threshold.

13. The computing device of claim 10, wherein said evaluating the importance uses Equation 2:
$${I}_{l} = 1 - 𝔼 \frac{{X}_{i n}^{T} {X}_{out}}{‖ {X}_{i n} ‖ ‖ {X}_{out} ‖} \qquad Equation 2$$
where Iₗ is the importance of layer l, Xᵢₙ is an input of layer l, and Xₒᵤₜ is an output of layer l.

14. The computing device of claim 10, wherein said assigning the compression ratio uses Equation 3:
$$1 - {C}_{l} = 1 / {p}_{l} P ( 1 - {C}_{a v g} ) Softmax ( \frac{α {I}_{l} {p}_{l}}{{s}_{l} μ} ) \qquad Equation 3$$
where Cₗ is the compression ratio for a layer l, pₗ is the number of parameters for layer l, P is the total number of parameters for the neural network, C_{avg} is the target compression ratio, Iₗ is the importance of layer l, sₗ is the activation sparsity of layer l, and α and μ are hyperparameters.

15. The computing device of claim 10, further configured to:
evaluate a rank of a weight matrix for each layer;
select a compression strategy for each layer based on the rank of the weight matrix, the compression strategy being one of quantization, low-rank decomposition, or joint quantization and low-rank decomposition.

16. The computing device of claim 15, wherein the selected compression strategy is low-rank decomposition when the rank is less than a first threshold, the selected compression strategy is joint quantization and low-rank decomposition when the rank is between the first threshold and a second threshold, and the selected compression strategy is quantization when the rank is above the second threshold.

17. The computing device of claim 10, further configured to:
insert, between each layer, a dynamic sparsity evaluator, the dynamic sparsity evaluator being configured to evaluate a sparsity of a preceding layer during inference, and to dynamically compress a subsequent layer based on the sparsity of the preceding layer.

18. The computing device of claim 10, wherein the neural network is one of a Large Language Model (LLM) or a Large Multimodal Model (LMM).

19. A computer readable medium for compressing a neural network, having stored thereon executable code for execution by a processor of a computing device, the executable code comprising instructions for:
running the neural network using calibration data as input;
evaluating a sparsity of each layer of the neural network during execution over the calibration data;
evaluating an importance of each layer of the neural network during execution over the calibration data;
assigning a compression ratio to each layer of the neural network, the compression ratio for a given layer being a function of the sparsity and the importance of the given layer, and of a target compression ratio for the neural network; and
compressing each layer of the neural network according to the assigned compression ratio.
